(19) United States
(12) Patent Application Publication
(10) Pub. No.: US 2003/0006964 A1
(43) Pub. Date: Jan. 9, 2003

(54) Roller positioning structure

(76) Inventor: Robert Cheng, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/897,020

(22) Filed: Jul. 3, 2001

(51) Int. Cl. G09G 5/08

(52) U.S. Cl. 345/163

(57) ABSTRACT

The present invention provides a roller positioning structure comprising a bottom seat, a roller, and a positioning part. The bottom seat has a pivotal portion letting the roller be pivotally disposed thereon. One end face of the roller is hollowed out, and the other end face thereof forms a sidewall to receive the positioning part. The positioning part has a connection end connected on the bottom seat. Projective veins and a resilient sheet are disposed between the positioning part and the roller. A press portion contacting the projective veins is convexly disposed on the resilient sheet. When the roller is poked, the press portion will jump on the projective veins to generate positioning touch, thereby obtaining more sensible positioning touch and reducing emitted sound.

### FIELD OF THE INVENTION

The present invention relates to a roller positioning structure and, more particularly, to a positioning structure capable of letting positioning touch be more sensible and reducing emitted sound when a roller is poked.

### BACKGROUND OF THE INVENTION

Along with quick development of information technology, computers have become popular electric appliances in our everyday lives. Most of commercially available computer software have been designed so that a window on a computer screen can be scrolled to achieve the object of fast browsing contents of files by poking a roller on a mouse or a keyboard, thereby facilitating operation of computers.

However, most conventional roller positioning structures disposed on mice or keyboards have drawbacks. FIG. 1 shows a prior art roller positioning structure, wherein a pivotal portion 10a and a receiving groove 11a are disposed on a bottom seat 1a of a mouse or a keyboard. An axial rod 12a is pivotally disposed on the pivotal portion 10a. The axial rod 12a has a roller 14a with an optical grating 13a and a gear 15a corresponding to the receiving groove 11a. The receiving groove 11a can receive a spring 16a and a ball 17a. The gear 15a is used to press the ball 17a and the spring 16a into the receiving groove 11a so that the ball 17a can be embedded between two teeth of the gear 15a. When a user pokes the roller 14a to drive the gear 15a on the axial rod 12a to rotate, the ball 17a will jump through the rotation of the gear 15a so that the user can acquire positioning touch.

However, because the ball 17a is clipped between the gear 15a and the spring 16a and is not positioned, it will continually gives out sound due to collision with the gear 15a when jumping on the gear 15a, and lets positioning effect be inferior when the roller 14a is poked.

Accordingly, the above roller positioning structure has inconvenience and drawbacks in practical use. The present invention aims to resolve the problems in the prior art.

### SUMMARY OF THE INVENTION

The primary object of the present invention is to provide a roller positioning structure capable of letting positioning touch be more sensible and reducing emitted sound when a roller is poked so as to achieve better positioning effect.

To achieve the above object, the present invention provides a roller positioning structure comprising a bottom seat, a roller, and a positioning part. The bottom seat has a pivotal portion letting the roller be pivotally disposed thereon. One end face of the roller is hollowed out, and the other end face thereof forms a sidewall to receive the positioning part. The positioning part has a connection end connected with the bottom seat. Projective veins and a resilient sheet are disposed between the positioning part and the roller. A press portion contacting the projective veins is convexly disposed on the resilient sheet. When the roller is poked, the press portion will jump on the projective veins to generate positioning touch, thereby achieving the above object.

The various objects and advantages of the present invention will be more readily understood from the following detailed description when read in conjunction with the appended drawing, in which:

### BRIEF DESCRIPTION OF THE DRAWINGS

FIG. 1 is an exploded perspective view of a prior art roller positioning structure;

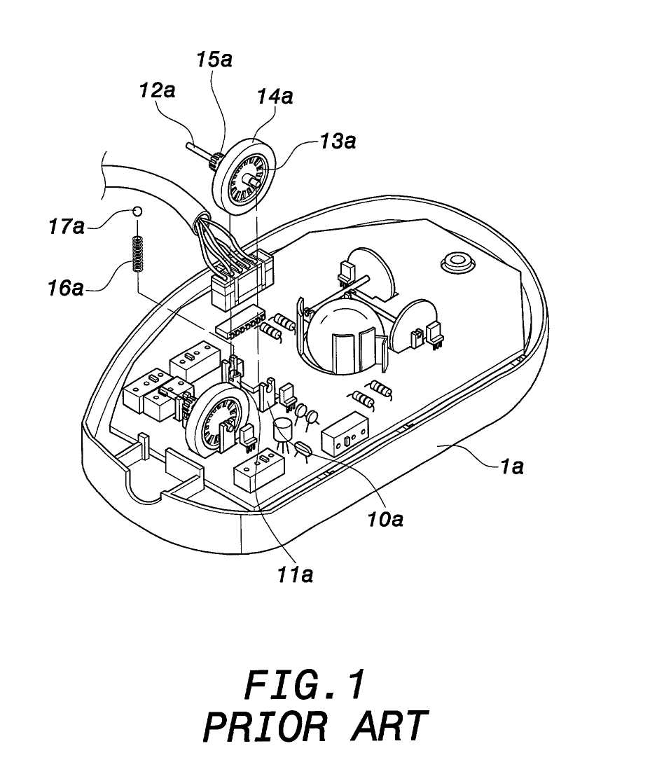

FIG. 2 is an exploded perspective view of the present invention;

FIG. 3 is a perspective view of the present invention;

FIG. 4 is an exploded perspective view of a roller and a positioning part of the present invention;

FIG. 5 is a cross-sectional view of a first action of the present invention;

FIG. 6 is a cross-sectional view of a second action of the present invention;

FIG. 7 is an exploded perspective view of a roller and a positioning part according to another embodiment of the present invention; and

FIG. 8 is an exploded perspective view of a roller and a positioning part according to yet another embodiment of the present invention.

### DETAILED DESCRIPTION OF THE PREFERRED EMBODIMENTS

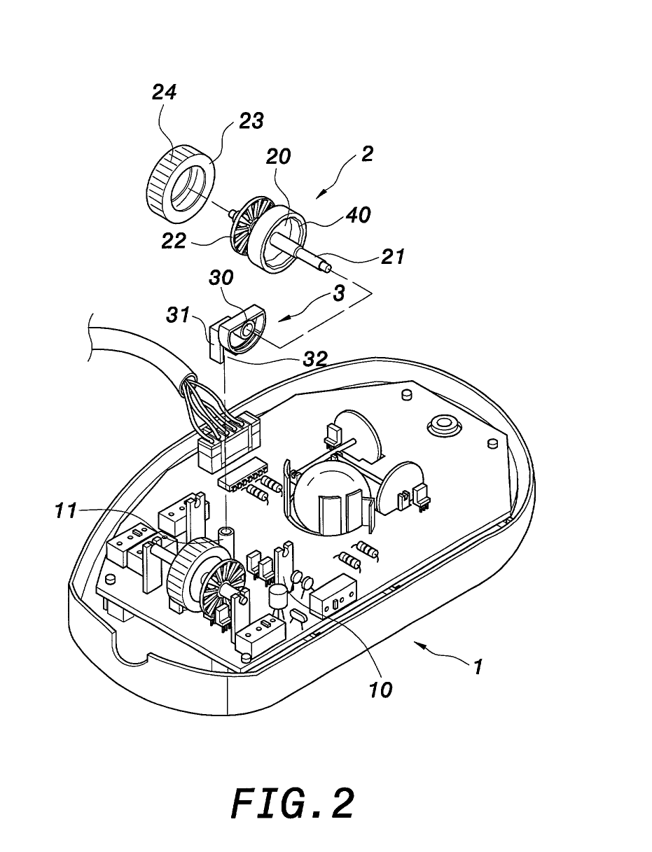

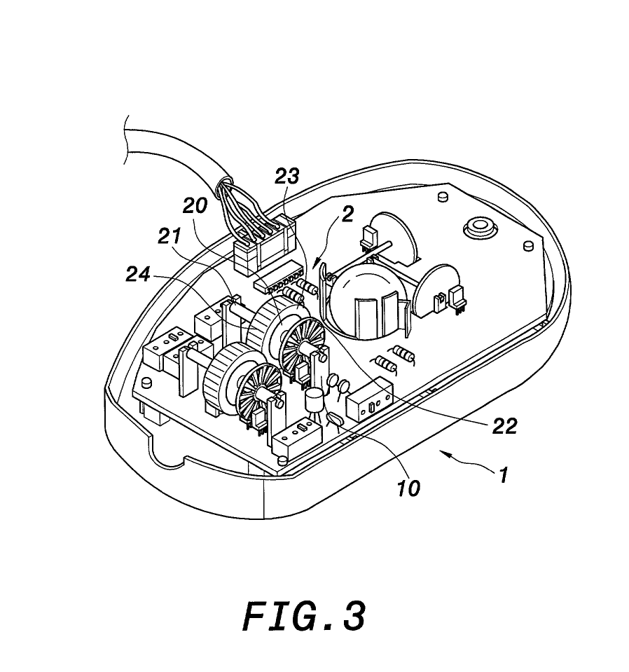

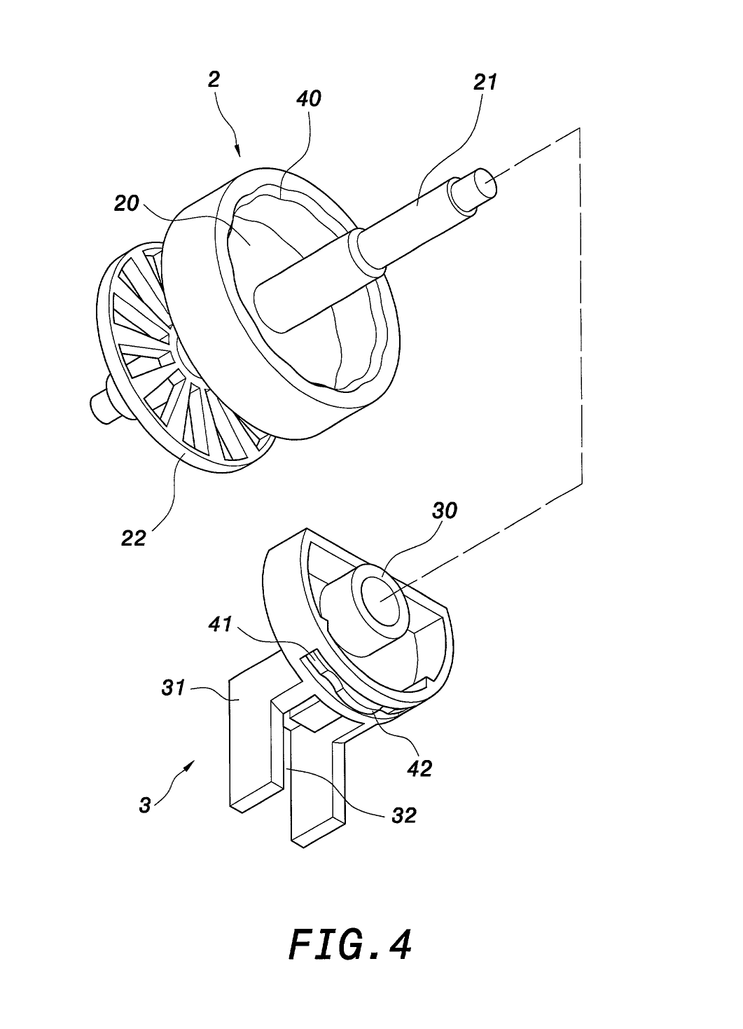

As shown in FIGS. 2 to 4, the present invention provides a roller positioning structure comprising a bottom seat 1, a roller 2, and a positioning part 3. The bottom seat 1 can be the bottom of a mouse, a keyboard, or a controller. The bottom seat 1 has a pivotal portion 10 on a predetermined position thereof.

The roller 2 is a circular frame. One end face of the roller 2 is hollowed out, and the other end face thereof forms a sidewall 20. The sidewall 20 and the roller 2 are coaxial. An axial rod 21 penetrating through the sidewall 20 is fixedly disposed at the axis of the roller 2. The axial rod 21 is pivotally disposed on the pivotal portion 10 of the bottom seat 1 so that the roller 2 can rotate on the pivotal portion 10. An optical grating 22 can be fixedly disposed on the axial rod 21.

A soft ring 23 can be slipped on the roller 2. Skid-proof veins are formed on the peripheral face of the soft ring 23 to increase the contact friction of a user with the roller 2, hence letting the operation be more smooth when the user pokes the roller 2.

The positioning part 3 is roughly a semicircular panel with a through pivotal hole 30. The pivotal hole 30 is slipped onto the axial rod 21 of the roller 2 so as to be received in the roller 2. A connection end 31 is disposed on an outer side face of the positioning part 3. The connection end 31 can be directly joined on the bottom seat 1; or a fixing part 11 is first disposed on the bottom seat 1, a groove 32 matched with the fixing part 11 is disposed on the connection end 31, and the groove 32 is then slipped onto the fixing part 11 to let the positioning part 32 be joined on the fixing part 11 of the bottom seat 11. Therefore, when the roller 2 rotates, the positioning part 3 will not rotate therewith.

The present invention is characterized in that projective veins 40 and a resilient sheet 41 are disposed between the roller 2 and the positioning part 3. The projective veins 41 are a plurality of corrugations and are uniformly and annularly disposed on the peripheral face of an inner wall of the roller 2. The resilient sheet 41 is disposed on an outer wall of the positioning part 3. A press portion 42 exactly contacting the projective veins 40 is convexly disposed on the resilient sheet 41. A roller positioning structure is thus formed. When the roller is poked to rotate, the press portion 42 of the positioning part 3 will jump on the projective veins 40 to generate positioning touch of the roller 2.

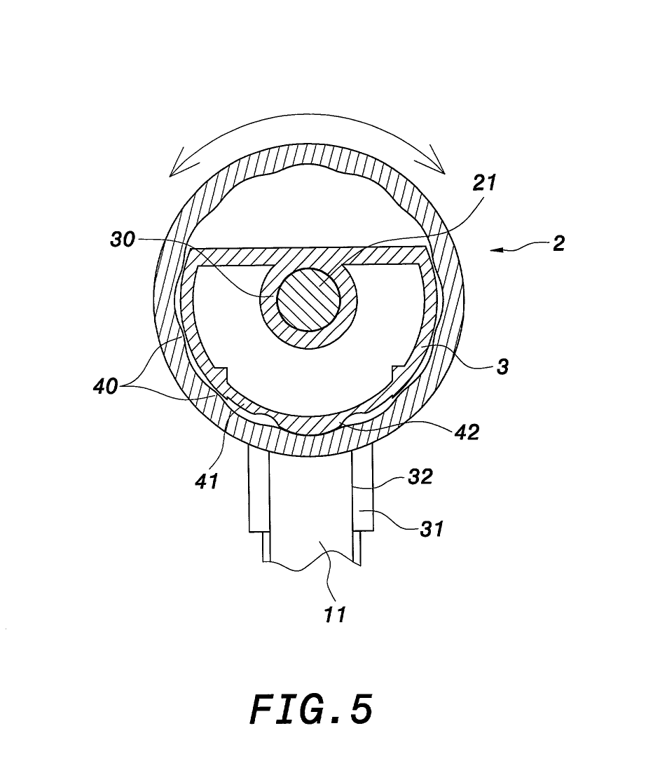

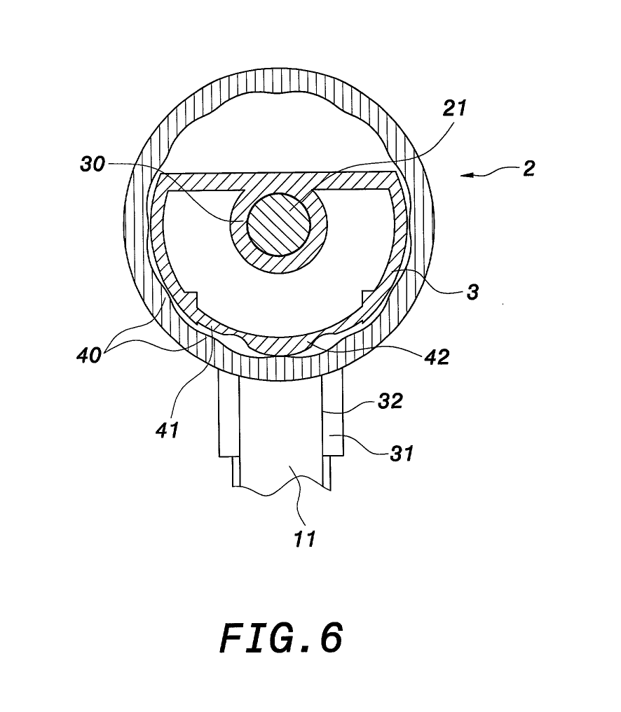

As shown in FIG. 5, the press portion 42 is in a natural state and situated between two corrugations of the projective veins 40. Because the connection end 31 is disposed on the fixing part 11, when the roller 2 is poked, the positioning part 3 will not rotate with the roller 2. Moreover, the press portion 42 will shrink inwards (as shown in FIG. 6) due to movement of the projective veins 40, thereby facilitating rotation of the roller 2.

As shown in FIG. 6, when the roller 2 is continually poked, the press portion 42 will again be situated between two corrugations of the projective veins 40 due to movement of the projective veins 40, thereby restoring to its natural state (as shown in FIG. 5). Therefore, the press portion 42 can always jump on the projective veins 40 to generate deformed and natural states, letting a user have more sensible positioning touch when poking the roller 2. Better positioning effect can thus be achieved.

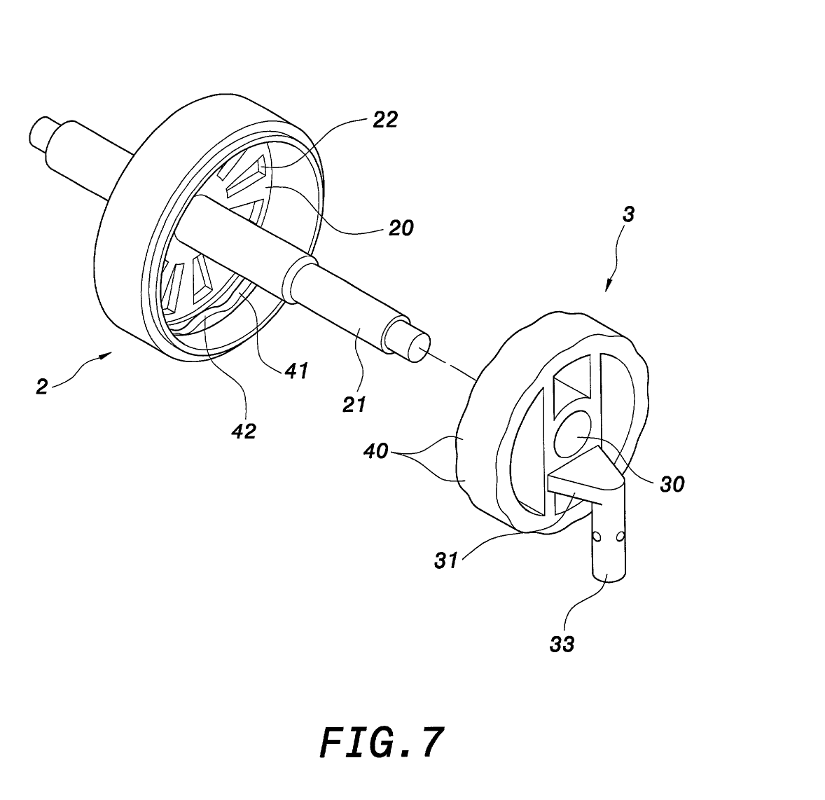

FIG. 7 shows an exploded perspective view of the roller and the positioning part according to another embodiment of the present invention. The optical grating 22 can be disposed on the sidewall 20 of the roller 2 so that the optical grating 22 and the roller 2 form an assembly. The resilient sheet 41 is disposed on the peripheral face of the inner wall of the roller 2. The press portion 42 is also convexly disposed on the resilient sheet 41.

The positioning part 3 is a circular panel. A projective pole 33 can be disposed at the connection position of the connection end 31 with the fixing part 11 of the bottom seat 1. The projective pole 33 is slipped into the fixing part 11. The projective veins 40 are uniformly and annularly disposed on the peripheral face of the outer wall of the positioning part 3. The positioning part 3 and the roller 2 are coaxial so that the press portion 42 can always contact the projective veins 40 when the pivotal hole 30 is slipped onto the axial rod 21. Thereby, the press portion 42 of the roller 2 will jump on the projective veins 40 of the positioning part 3 to achieve the object of the present invention.

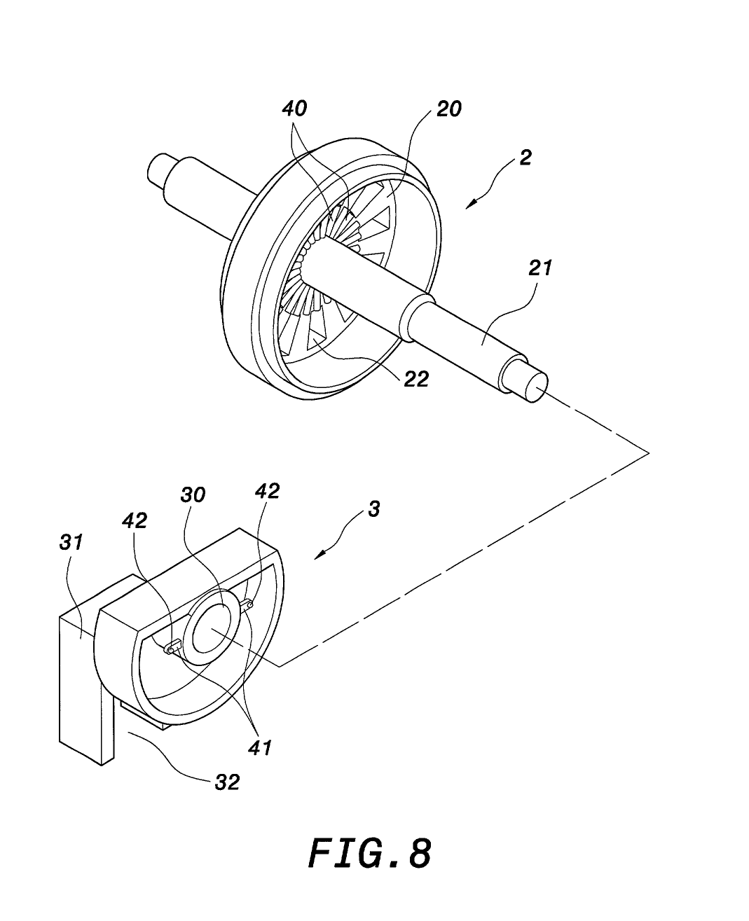

FIG. 8 shows an exploded perspective view of the roller and the positioning part according to yet another embodiment of the present invention. The projective veins 40 are disposed on an inner side face of the sidewall 20 of the roller 2, and uniformly enclose the axis of the roller 2 so that the projective veins 40 are situated on the same plane.

The resilient sheet 41 is disposed on an end face of the positioning part 3 near the sidewall 20. One end of the resilient sheet 41 joins the positioning part 3, and the other end thereof is a free end. The free end has a projective point-type press portion 42. The positioning part 3 and the roller 2 are coaxial so that the press portion 42 can always contact the projective veins 40 when the pivotal hole 30 is slipped onto the axial rod 21.

Simultaneously, the number of the resilient sheet 41 on the positioning part 3 can increase, and each of the resilient sheets 41 has a press portion 42 convexly disposed thereon. Thereby, positioning touch can be more enhanced to achieve the object of the present invention.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A roller positioning structure comprising:
a bottom seat having a pivotal portion;
a roller, one end face thereof being hollowed out, and the other end face thereof forming a sidewall, said roller being pivotally disposed on said pivotal portion; and
a positioning part connected on said bottom seat and received in said roller, a plurality of projective veins and a resilient sheet being disposed between said positioning part and said roller, a press portion contacting said projective veins being convexly disposed on said resilient sheet;
whereby said press portion can jump on said projective veins to generate positioning touch when said roller is poked.

2. The roller positioning structure as claimed in claim 1, wherein said bottom seat is a bottom of a mouse, a keyboard, or a controller.

3. The roller positioning structure as claimed in claim 1, wherein a soft ring can further be slipped on said roller.

4. The roller positioning structure as claimed in claim 3, wherein a peripheral face of said soft ring has skid-proof veins.

5. The roller positioning structure as claimed in claim 1, wherein said roller has an optical grating thereon.

6. The roller positioning structure as claimed in claim 5, wherein said optical grating is disposed on said sidewall of said roller.

7. The roller positioning structure as claimed in claim 1, wherein an axial rod penetrating through said sidewall is fixedly disposed at an axis of said roller, and said axial rod is pivotally disposed on said pivotal portion of said bottom seat.

8. The roller positioning structure as claimed in claim 7, wherein said axial rod has an optical grating thereon.

9. The roller positioning structure as claimed in claim 7, wherein a pivotal hole can be slipped onto said axial rod, and said pivotal hole is disposed on said positioning part.

10. The roller positioning structure as claimed in claim 1, wherein said positioning part has a connection end connected on said bottom seat.

11. The roller positioning structure as claimed in claim 10, wherein said connection end has a groove, a fixing part matched with said groove is disposed on said bottom seat, and said groove is slipped onto said fixing part.

12. The roller positioning structure as claimed in claim 10, wherein said connection end has a projective pole, a fixing part matched with said projective pole is disposed on said bottom seat, and said projective pole is slipped into said fixing part.

13. The roller positioning structure as claimed in claim 1, wherein said projective veins are a plurality of corrugations.

14. The roller positioning structure as claimed in claim 1, wherein said projective veins are annularly disposed on a peripheral face of an inner wall of said roller, and said resilient sheet is disposed on an outer wall of said positioning part.

15. The roller positioning structure as claimed in claim 1, wherein said projective veins are annularly disposed on a peripheral face of an outer wall of said positioning part, which is a circular panel coaxial with said roller, and said resilient sheet is disposed on a peripheral face of an inner wall of said roller.

16. The roller positioning structure as claimed in claim 1, wherein said projective veins enclose an axis of said roller and are situated on the same plane, and said resilient sheet is disposed on an end face of said positioning part near said sidewall to let said positioning part and said roller be coaxial.

17. The roller positioning structure as claimed in claim 16, wherein one end of said resilient sheet joins said positioning part, and the other end thereof is a free end.
